(19) United States
(12) Patent Application Publication
(10) Pub. No.: US 2025/0306486 A1
(43) Pub. Date: Oct. 2, 2025

(54) TONER AND METHOD OF PRODUCING THE SAME

(71) Applicant: SHARP KABUSHIKI KAISHA, Sakai City (JP)

(72) Inventor: Yuki HIRANO, Sakai City (JP)

(21) Appl. No.: 19/053,700

(22) Filed: Feb. 14, 2025

(30) Foreign Application Priority Data
Mar. 29, 2024 (JP) 2024-056115

(51) Int. Cl. G03G 9/08; G03G 9/087; G03G 9/09; G03G 9/097

(52) U.S. Cl. CPC G03G 9/0825; G03G 9/081; G03G 9/0819; G03G 9/08755; G03G 9/08782; G03G 9/0906; G03G 9/09708; G03G 9/0975

(57) ABSTRACT

A toner has the following constitution. The toner particle contains an inorganic fine particle having a mean particle size in a range from 10 nm to 60 nm. The inorganic fine particle is at least one selected from the group consisting of strontium titanate, silica coated with alumina, titania, and the like. When layers having depths of 0 nm to 10 nm, 10 nm to 100 nm, and 100 nm or more from the surface of the toner particle are defined as toner layers A to C, respectively, an abundance ratio of the inorganic fine particle is the highest in the toner layer B. At the interface (toner layer B) in the electronic image of the toner particle cross section, an interface α having a small abundance ratio of the inorganic fine particle and an interface β having a large abundance ratio of the inorganic fine particle are present, and the length of both interfaces is 2 μm or more. The abundance ratio of the inorganic fine particle in the interface α is 15% or less with respect to the interface β.

### CROSS-REFERENCE TO RELATED APPLICATION

The present application claims priority from Japanese Application JP2024-056115, filed on Mar. 29, 2024, the content of which is hereby incorporated by reference into this application

### FIELD OF THE DISCLOSURE

The present disclosure relates to a toner and a method of producing the same.

### BACKGROUND ART

In an electrophotographic image forming apparatus such as a copying machine, a multifunction peripheral, a printer, or a facsimile apparatus, a developer (a toner in one component development, or a toner and a carrier in two-component development) is conveyed to a surface of a photosensitive member on which an electrostatic latent image is formed, thereby forming a toner image on the photosensitive member. In general, a toner in which an external additive is attached to a surface of a toner particle (toner core) containing a binder resin as a main component is used.

In a case where the charge amount distribution of the toner in the developer is locally different and unevenness in the charge amount (hereinafter referred to as charging unevenness) occurs, a portion where the potential difference between the surface potential of the photosensitive member and the developing bias partially occurs is generated, and fogging is likely to occur. The fogging refers to a phenomenon in which a toner is developed in a non-image portion where the toner is not originally developed.

As a method of solving this problem, there is a method of adding inorganic fine particles having a lower resistance value than the toner particles as an external additive. Such inorganic fine particles function as a charge adjustment agent in the toner, and can propagate locally charged negative charges to surrounding toner particles or release them into the air.

As described above, as a toner containing inorganic fine particles as an external additive, a toner containing hydrophobized titania (titanium oxide) particles having a mean particle size in a range from 20 nm to 100 nm as an external additive and having an abundance ratio of the titania particles on the surfaces of the toner particles in a range from 2% to 20% is known.

### SUMMARY

### Technical Problem

However, as the addition amount of the inorganic fine particles as an external additive increases, performance deterioration such as deterioration of the low-temperature fixability of the toner, an excessive increase in the fluidity of the toner, and an excessive decrease in the charge amount of the toner are caused. Therefore, there is a problem that it is necessary to limit the addition amount of the inorganic fine particles, and it is difficult to sufficiently exhibit the function of the inorganic fine particles as a charge adjustment agent.

The content of the present disclosure has been found in view of such circumstances, and a main object thereof is to provide a toner capable of increasing the amount of inorganic fine particles added to the toner, and thus having excellent charging characteristics and fixability and capable of suppressing the occurrence of fogging, and a method of producing the toner.

### Solution to Problem

A toner of the present disclosure made in order to solve the above problem includes a toner particle containing a binder resin, a colorant and a release agent, wherein the toner particle contains an inorganic fine particle having a mean particle size in a range from 10 nm to 60 nm,
the inorganic fine particle is at least one selected from the group consisting of a strontium titanate fine particle, an alumina-coated silica fine particle, a titania fine particle, an alumina fine particle, a zinc oxide fine particle, a cerium oxide fine particle, and a calcium carbonate fine particle,
when a layer having a depth from a surface of the toner particle in a range of 0 nm to 10 nm is defined as a toner layer A, a layer having a depth in a range from 10 nm to 100 nm is defined as a toner layer B, and a layer having a depth of 100 nm or more is defined as a toner layer C, the toner layer B has an abundance ratio of the inorganic fine particle higher than an abundance ratio of the toner layer A and the toner layer C, in an electronic image of a cross-section of the toner particle obtained by a scanning electron microscope, when a region corresponding to the toner layer B is defined as an interface, an interface α having a small abundance ratio of the inorganic fine particle and an interface β having a large abundance ratio of the inorganic fine particle are present,
an interface length of the interface α and the interface β is 2 μm or more, and
an abundance ratio of the inorganic fine particle in the interface α is 15% or less of an abundance ratio of the inorganic fine particle in the interface β.

In the toner described above, the inorganic fine particle is preferably at least one selected from the group consisting of a strontium titanate fine particle, an alumina-coated silica fine particle, and a titania fine particle.

In the toner described above, an abundance ratio of the inorganic fine particle in the interface α is preferably 10% or less in an electronic image of a cross-section of the toner particle obtained by a scanning electron microscope.

In the toner described above, an abundance ratio of the inorganic fine particle in the interface β is preferably 90% or more in an electronic image of a cross-section of the toner particle obtained by a scanning electron microscope.

In the toner described above, an adhesion strength of the inorganic fine particle to the toner particle is preferably 90% or more.

In the toner described above, a content of the inorganic fine particle in the toner particle is preferably in a range from 2 mass % to 10 mass %.

In the toner described above, a silica fine particle as an external additive is preferably attached to a surface of the toner particle, and a coverage ratio of the toner particle surface by the silica fine particle is preferably in a range from 70% to 110%.

In the toner described above, an adhesion strength of the silica fine particle to the toner particle is preferably in a range from 50% to 80%.

In order to solve the above problems, a method of producing a toner according to the present disclosure includes:
a melt-kneading step of melt-kneading a mixture of raw materials containing a binder resin, a colorant, and a releasing agent;
a coarse pulverization step of coarsely pulverizing the melt-kneaded product obtained in the melt-kneading step;
an inorganic fine particle mixing step of mixing the coarsely pulverized product obtained in the coarse pulverization step with an inorganic fine particle;
a fine pulverization step of finely pulverizing a coarsely pulverized product containing the inorganic fine particle obtained in the inorganic fine particle mixing step; and
a classification step of classifying the finely pulverized product obtained in the fine pulverization step.

### Advantageous Effects of Disclosure

According to the toner and the method of producing the toner of the present disclosure, excellent effects are exhibited, such as being able to increase the amount of inorganic fine particles added to the toner, having excellent charging characteristics and fixability, and being able to suppress the occurrence of fogging.

### BRIEF DESCRIPTION OF THE DRAWINGS

FIG. 1 is a cross-sectional view schematically illustrating a toner according to the present embodiment.

FIG. 2 is a cross-sectional view schematically illustrating an example of a toner to which inorganic fine particles are added as an external additive.

FIG. 3 is an electronic image of a cross-section of a toner particle according to the present embodiment observed with a scanning electron microscope.

FIG. 4 is an enlarged view of the electronic image of FIG. 3 illustrating toner layers A-C.

FIG. 5 is an enlarged view of the electronic image of FIG. 3 illustrating the toner layers A-C.

FIG. 6 is an enlarged view of an interface α and an interface β in the electronic image of FIG. 3.

FIG. 7 is a front view schematically illustrating that a coarsely pulverized product and inorganic fine particles are mixed and then finely pulverized and classified in the method of producing a toner according to the present embodiment.

### DETAILED DESCRIPTION OF THE DISCLOSURE

Hereinafter, the toner of the present disclosure and a method of producing the toner will be described in detail. In the present disclosure, “externally added” means that an additive is added so as to adhere to the outer surface (surface) of an additive-receiving material, and “internally added” means that an additive is added so as to be contained inside an additive-receiving material.

### 1. Toner Particles (Toner Cores)

The toner particles according to the present embodiment include at least a binder resin, a colorant, and a release agent. Internal additives such as a colorant and a release agent are dispersed in the binder resin. Furthermore, the toner particles may contain an optional component as long as the effects according to the present disclosure are not impaired. The mean particle size of the toner particles can be appropriately selected depending on the intended purpose and is, for example, in a range from 4 μm to 8 μm.

The toner particles according to the present embodiment contain inorganic fine particles having a mean particle size in a range from 10 nm to 60 nm. Preferably, the mean particle size of the inorganic fine particles is in a range from 30 nm to 40 nm. Hereinafter, first, the inorganic fine particles will be described, and then each component such as the binder resin will be described.

### Inorganic Fine Particles

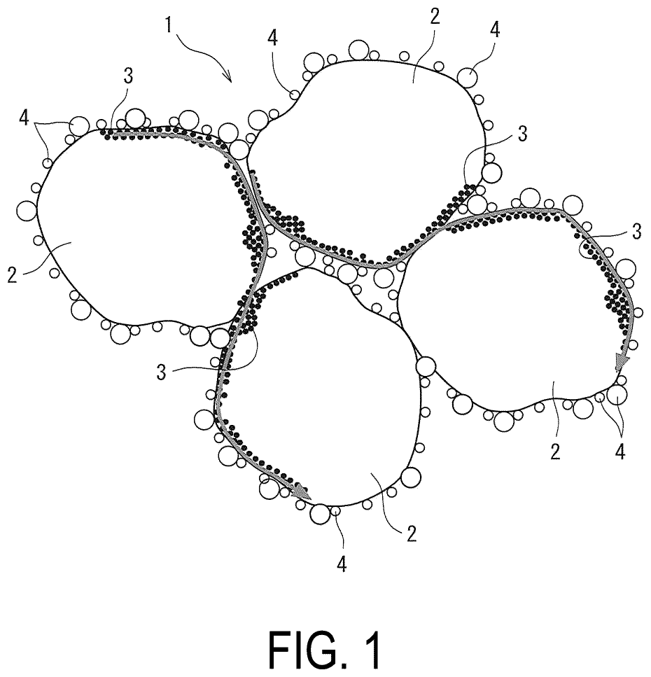

FIG. 1 is a cross-sectional view schematically illustrating a toner 1 according to the present embodiment. As illustrated in FIG. 1, a large amount of the inorganic fine particles 3 are embedded in a toner particle 2. The toner particle 2 has a portion in which a large amount of the inorganic fine particles 3 are embedded (interface β described below) and a portion in which the inorganic fine particles 3 are hardly present (interface α described below), in other words, the inorganic fine particles 3 are unevenly distributed.

Here, a mechanism in which the toner according to the present embodiment is capable of increasing the addition amount of the inorganic fine particles with respect to the toner, is excellent in charging characteristics and fixability, and is capable of suppressing the occurrence of fogging will be described.

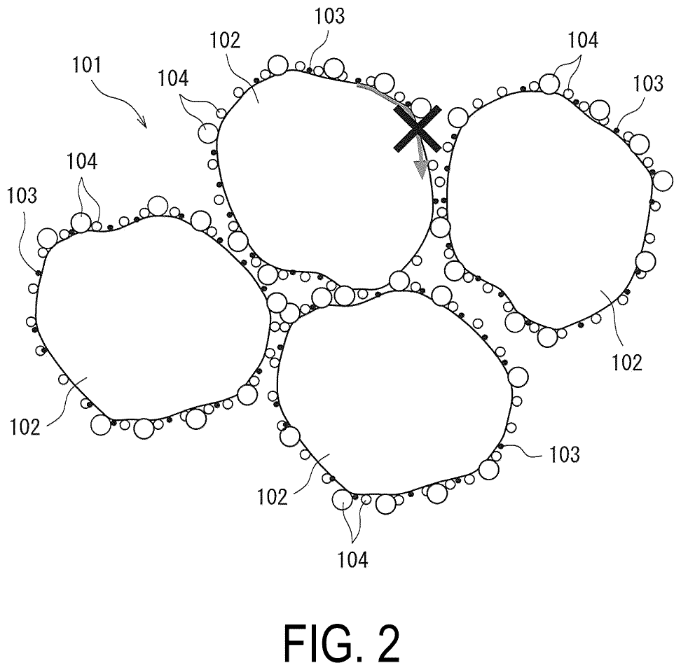

The developer containing the toner is frictionally charged by being stirred in the developer tank. FIG. 2 is a cross-sectional view schematically illustrating a toner 101 as an example of a toner to which inorganic fine particles are added as an external additive, and an external additive 103 (reference numeral 103, 104 denotes inorganic fine particles functioning as a charge adjustment agent) is evenly attached to the surface of a toner particle 102. As described above, when a charge adjustment agent is added as an external additive, it is necessary to limit the addition amount thereof. In the toner 101, even when the toner particles 102 come into contact with each other when the developer is stirred in the developer tank, a conductive path is not formed as indicated by an arrow in FIG. 2 because the addition amount of the charge adjustment agent 103 is small. In the case of attempting to form a conductive path in the toner 101, it is necessary to significantly increase the addition amount of the charge adjustment agent 103, but in this case, there is a problem that performance deterioration such as deterioration of the low-temperature fixability of the toner, an excessive increase in the fluidity of the toner, and an excessive decrease in the charge amount of the toner is caused.

On the other hand, in the toner according to the present embodiment, a large amount of inorganic fine particles as a charge adjustment agent are embedded inside the toner particle (toner layer B described below), and the toner has a portion (interface β described below) in which a large amount of inorganic fine particles are embedded and a portion (interface α described below) in which the inorganic fine particles are hardly present. In this case, since the apparent addition amount (coverage ratio) of the inorganic fine particles when the toner particles are viewed from the surface is small, it is possible to suppress a decrease in toner performance such as a decrease in charge amount or an increase in fluidity. Then, when the developer is stirred in the developer tank, portions in which a large amount of the inorganic fine particles are embedded (interfaces β described below) come into contact with each other, and a conductive path as indicated by an arrow in FIG. 1 is formed. As a result, a difference in toner charge amount in the developer can be alleviated.

In addition, in the toner according to the present embodiment, since the inorganic fine particles are present in a state of being embedded in the inside of the toner particle (toner layer B described below), even in a case where the addition amount of the inorganic fine particles is increased to an excessive amount in a case where the inorganic fine particles are added as an external additive, it is possible to suppress the detachment of the inorganic fine particles from the toner particle and to suppress a change in charging characteristics throughout the life (product life).

That is, in the toner according to the present embodiment, since a portion in which a large amount of the inorganic fine particles are embedded (an interface β described below) is locally present, it is possible to alleviate an environmental charge difference (a charge amount in a low humidity environment−a charge amount in a high humidity environment) while suppressing a decrease in charging, in other words, it is possible to realize a toner having excellent environmental charging characteristics. In addition, the toner according to the present embodiment exhibits an effect of alleviating an environmental charge difference while suppressing a decrease in charge, and thus it is possible to suppress the occurrence of fogging even after the toner is supplied to the developer or after continuous image formation.

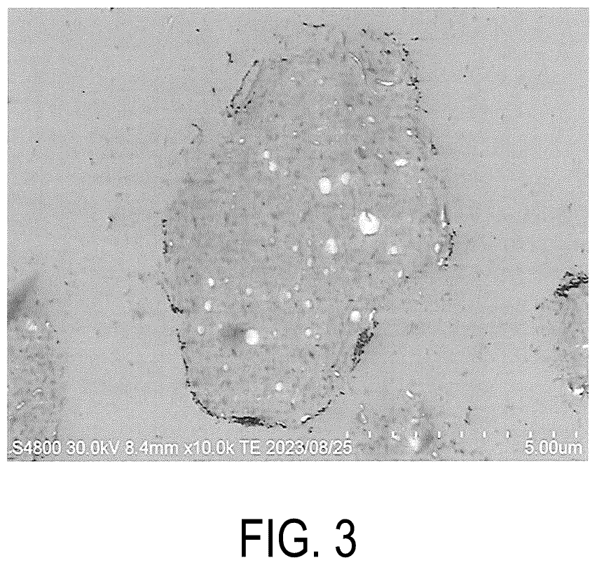

Next, the distribution of the inorganic fine particles in the toner particles according to the present embodiment will be specifically described with reference to FIGS. 3 to 6.

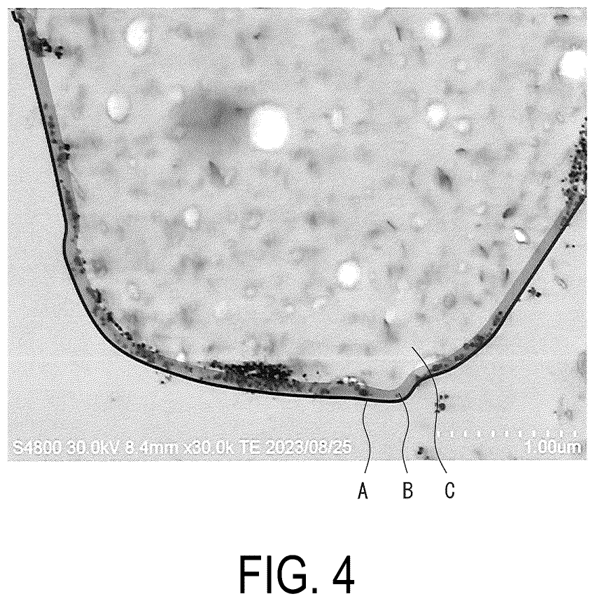

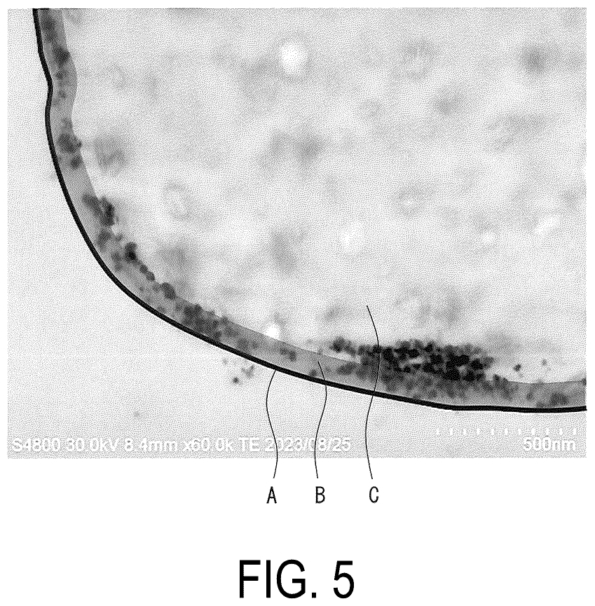

FIG. 3 is an electronic image of a cross-section of the toner particle according to the present embodiment observed with a scanning electron microscope, and FIGS. 4 and 5 illustrate toner layers A to C by enlarging the electronic image of FIG. 3. Here, the toner layer A is a layer in which the depth from the surfaces of the toner particles is in a range from 0 nm to 10 nm, the toner layer B is a layer in which the depth is in a range from 10 nm to 100 nm, and the toner layer C is a layer in which the depth is 100 nm or more. As can be seen from FIGS. 4 and 5, in the toner particle according to the present embodiment, the concentration of the inorganic fine particles in the toner layer B is higher than the concentrations of the inorganic fine particles in the toner layer A and the toner layer C. That is, the abundance ratio of the inorganic fine particles in the toner layer B is higher than the abundance ratios of the inorganic fine particles in the toner layer A and the toner layer C.

In addition, in the toner particle according to the present embodiment, in an electronic image of a cross-section of the toner particle obtained by a scanning electron microscope, when a region corresponding to the toner layer B is defined as an interface, an interface α having a small abundance ratio of the inorganic fine particles and an interface β having a large abundance ratio of the inorganic fine particles are present. The interface length of the interface α and the interface β is 2 μm or more.

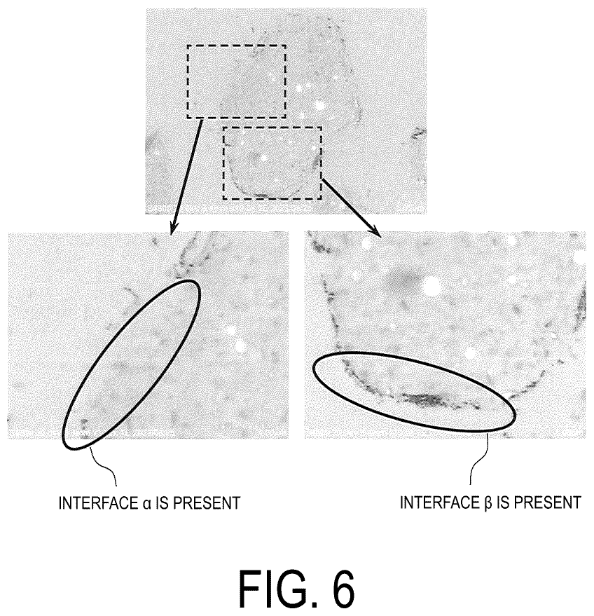

FIG. 6 is an enlarged view of the interface α and the interface β in the electronic image of FIG. 3, and it can be visually recognized that the interface α and the interface R having a certain length or more are present in the toner particle according to the present embodiment. The reason why the interface α and the interface β are present in the toner particle according to the present embodiment will be described in “3. Method of Producing Toner” described below.

In the toner particle according to the present embodiment, the abundance ratio of the inorganic fine particles in the interface α is 15% or less of the abundance ratio of the inorganic fine particles in the interface β. According to the production method according to the present embodiment described in “3. Method of Producing Toner” below, it is possible to produce a toner in which the inorganic fine particles are unevenly distributed in this manner, and by satisfying such a ratio of abundance ratios, the effects according to the present disclosure can be exhibited. The ratio of the abundance ratio is preferably 10% or less, and more preferably 5% or less.

The volume resistivity of the inorganic fine particles is preferably in a range from 2.0×10⁹ Ω·cm to 2.0×10¹⁴ Ω·cm. By setting the volume resistivity within the above range, the charge amount distribution of the toner can be sharpened, and a toner having more excellent charging characteristics can be obtained.

In the toner particle according to the present embodiment, the inorganic fine particle is at least one selected from the group consisting of strontium titanate fine particles, alumina-coated silica fine particles, titania fine particles, alumina fine particles, zinc oxide fine particles, cerium oxide fine particles, and calcium carbonate fine particles. These inorganic fine particles have a resistance value lower than that of the toner particle, and have a function of propagating the negative charge locally charged on the surface of the toner particle to the surrounding toner particles or releasing the negative charge into the air. When a large amount of the inorganic fine particles is added to the toner, a conductive path is formed as described above, charging unevenness can be reduced, and in particular, there is an effect of suppressing the occurrence of fogging in a low humidity environment.

Among these, the inorganic fine particle is preferably at least one selected from the group consisting of a strontium titanate fine particle, a silica fine particle coated with alumina, and a titania fine particle from the viewpoint of the volume resistance value thereof, imparting fluidity to the toner, and the like.

The strontium titanate fine particles can be produced by, for example, a normal-pressure heating reaction method. In the production by the normal-pressure heating reaction method, a mineral acid peptized product of a hydrolyzate of a titanium compound may be used as a titanium oxide source, and a water-soluble acidic metal compound may be used as a metal source other than titanium. As the strontium source, for example, a nitrate or a hydrochloride of strontium can be used, and examples of the nitrate include strontium nitrate, and examples of the hydrochloride include strontium chloride. The strontium titanate fine particles can be produced by adding an alkaline aqueous solution to a mixed solution of these raw materials at 60° C. or higher to cause a reaction, followed by an acid treatment. Since the strontium titanate fine particles thus obtained have a perovskite crystal structure, the stability of the charge amount with respect to environmental changes is enhanced, which is preferable.

The strontium titanate fine particles used as the inorganic fine particles may be silica-doped strontium titanate fine particles in which the strontium titanate fine particles are doped with silica. While a normal strontium titanate fine particle alone has an angular shape, the silica-doped strontium titanate fine particle has a rounded shape with rounded corners due to doping with silica. Therefore, the silica-doped strontium titanate fine particles are more excellent in dispersibility.

The silica-doped strontium titanate fine particles can be produced, for example, by the following procedures (1) to (5).
(1) Metatitanic acid obtained by a sulfuric acid method is subjected to a desulfurization bleaching treatment, and then, a desulfurization treatment is performed by adding an aqueous sodium hydroxide solution. Subsequently, the obtained solution is neutralized with hydrochloric acid, and filtered and washed with water to obtain a washed cake.
(2) Water is added to the washed cake to form a slurry, which is then subjected to a deflocculation treatment by adding hydrochloric acid. The obtained solution is referred to as a solution 1. The solution 1 is mixed with a solution 2 formed by an aqueous strontium chloride solution and a solution 3 formed by an aqueous sodium silicate solution. The mixing ratio of the solution 1, the solution 2, and the solution 3 is determined such that the molar ratio (Sr+Si)/Ti is in a range from 1.18 to 2.10.
(3) The mixed solution is heated to 90° C. in a nitrogen atmosphere, stirred for 2 hours while adding an aqueous sodium hydroxide solution, and then, stirred at 90° C. for 1 hour to allow the mixture to react.
(4) After completion of the reaction, the slurry is cooled to 50° C. and hydrochloric acid is added. The mixture is stirred for 1 hour, and the resulting precipitate is washed, separated by filtration, and dried.
(5) The obtained dried product is pulverized with a blender for 1 minute, and coarse particles are removed with a sieve to obtain a fine powder. The obtained fine powder base bodies are surface-coated with a silane coupling agent. Examples of a surface coating method using a silane coupling agent include a surface treatment commonly used in the art which uses hexamethyldisilazane (HMDS), dimethyl-dichlorosilane (DDS), octylsilane (OTAS), or polydimethylsiloxane (PDMS).

The mean particle size of the strontium titanate fine particles is preferably in a range from 20 nm to 50 nm. The resistance value is preferably in a range from 3.0×10⁹Ω to 5×10¹⁰Ω.

The silica fine particle coated with alumina is a silica fine particle having a surface coated with aluminum hydroxide, and the surface is preferably subjected to a hydrophobic treatment with a silane compound. Examples of the hydrophobic treatment include surface coating with a silane coupling agent.

Examples of the silica fine particles in the alumina-coated silica fine particles include silica fine particles commonly used in the art, for example, fumed silica obtained by burning silicon tetrachloride, dry-process silica such as arc process silica obtained by atomizing silica in a gas phase by high energy such as plasma, precipitated silica synthesized under an alkaline condition using a sodium silicate aqueous solution as a raw material, wet-process silica such as gel process silica synthesized under an acidic condition, colloidal silica obtained by polymerizing acidic silicic acid under an alkaline condition, sol-gel process silica obtained by hydrolyzing an organic silane compound, and the like.

The mean particle size of the alumina-coated silica fine particles is preferably in a range from 10 nm to 40 nm. Further, the resistance value is preferably 1.0×10¹¹Ω or less.

The titania fine particles may be anatase-type titania fine particles or rutile-type titania fine particles. As a method of producing rutile-type titania fine particles, for example, there is a method described in JP 2001-26423A, that is, a method in which an aqueous solution of titanium tetrachloride is hydrolyzed to prepare a fine titania sol having a rutile nucleus, and the sol is separated and then heat-treated to obtain titania fine particles. As a method of producing anatase-type titania fine particles, for example, there is a method described in JP 2000-10335A, that is, a method in which a solution obtained by dissolving a raw material such as ilmenite ore in sulfuric acid is hydrolyzed, granulated, dried, and then calcined at a high temperature to obtain titania fine particles.

In the toner according to the present embodiment, the abundance ratio of the inorganic fine particles in the interface α is preferably 10% or less and more preferably 5% or less in an electronic image of a cross section of the toner particle obtained by a scanning electron microscope. When the abundance ratio of the inorganic fine particles in the interface α exceeds the upper limit, a conductive path by the inorganic fine particles may be formed up to the interface α as in the interface J. Due to the presence of the interface α at which the abundance ratio of the inorganic fine particles is sufficiently small, the apparent addition amount (coverage ratio) of the inorganic fine particles when the toner particle is viewed from the surface decreases, and it is possible to suppress a decrease in toner performance such as a decrease in charge amount and an increase in fluidity.

In the toner according to the present embodiment, the abundance ratio of the inorganic fine particles in the interface 3 is preferably 90% or more and more preferably 95% or more in an electronic image of a toner particle cross section obtained by a scanning electron microscope. When the abundance ratio of the inorganic fine particles in the interface β is within the above range, the inorganic fine particles present in the interface β form a conductive path in the developer, so that the charging unevenness can be reduced, and consequently, the occurrence of fogging can be suppressed. When the abundance ratio of the inorganic fine particles in the interface β is less than the lower limit, a conductive path may not be formed, and the effect of reducing charging unevenness may be reduced.

The adhesion strength of the inorganic fine particles to the toner particles according to the present embodiment is preferably 90% or more, and more preferably 95% or more. In a toner to which inorganic fine particles are added as an external additive, the adhesion strength of the external additive to the toner particles is about 60% to 80%, and the external additive is detached due to the application of a physical force accompanying the stirring of the developer, and external additive contamination occurs. On the other hand, in the toner according to the present embodiment, in a case where the inorganic fine particles are added as an external additive, the inorganic fine particles are added in an amount corresponding to an excessive amount, but the inorganic fine particles are present in a state of being embedded in the inside of the toner particle, and thus it is possible to set the adhesion strength within the above-described range, the detachment of the inorganic fine particles is suppressed, and the occurrence of contamination due to the inorganic fine particles can be suppressed. In addition, the effect of the inorganic fine particles as a charge adjustment agent can be maintained.

The content of the inorganic fine particles in the toner particles according to the present embodiment is preferably in a range from 2 mass % to 10 mass %, and more preferably in a range from 4 mass % to 8 mass %. In a toner to which inorganic fine particles as a charge adjustment agent are added as an external additive, the addition amount of the charge adjustment agent is about 0 part by mass to 1.5 parts by mass with respect to 100 parts by mass of toner particles, and addition of an amount more than this leads to deterioration of the toner performance as described above. On the other hand, in the toner according to the present embodiment, since the interface α in which the abundance ratio of the inorganic fine particles is small is present, the apparent addition amount (coverage ratio) of the inorganic fine particles when the toner particle is viewed from the surface is small, and thus, even in a case where the inorganic fine particles are added so as to have the content within the above range, a significant decrease in toner performance does not occur. In addition, when the content of the inorganic fine particles is within the above range, a sufficient amount of the inorganic fine particles are present in the toner layer B of the toner particle, and thus a conductive path is rapidly formed, so that the charging unevenness of the toner can be reduced.

### Binder Resin

The toner particles according to the present embodiment contain a binder resin. The binder resin is not particularly limited, and a resin used in the field of electrophotography can be used, and examples thereof include a polyester-based resin, a polystyrene-based resin such as a styrene-acrylic resin, a (meth) acrylic acid ester-based resin, a polyolefin-based resin, a polyurethane-based resin, and an epoxy-based resin. One of these resins may be used individually, or two or more may be used in combination. Among these, polystyrene-based resins and polyester-based resins are preferable, and polyester-based resins are particularly preferable.

The polystyrene-based resin is preferably a styrene-acrylic resin (styrene-acrylic copolymer resin), and examples of the styrene monomer that can be used as a resin raw material include styrene derivatives such as styrene, o-methylstyrene, m-methylstyrene, p-methylstyrene, α-methylstyrene, p-ethylstyrene, and 2, 4-dimethylstyrene. Examples of the acrylic monomer include acrylic acid derivatives and methacrylic acid derivatives such as acrylic acid, methyl acrylate, ethyl acrylate, n-butyl acrylate, isobutyl acrylate, propyl acrylate, octyl acrylate, 2-chloroethyl acrylate, phenyl acrylate, methacrylic acid, methyl methacrylate, ethyl methacrylate, propyl methacrylate, n-butyl methacrylate, isobutyl methacrylate, n-octyl methacrylate, 2-ethylhexyl methacrylate, phenyl methacrylate, and dimethylamino methacrylate.

Further, as the resin raw material, a vinyl monomer such as maleic anhydride, maleic acid monomethyl ester, maleic acid monoethyl ester, maleic acid monophenyl ester, maleic acid monoallyl ester, or divinylbenzene may be used.

The polyester-based resin used for the binder resin is usually produced by subjecting one or more selected from the group consisting of dihydric alcohol components and trihydric or higher polyhydric alcohol components and one or more selected from the group consisting of divalent carboxylic acids and trivalent or higher polyvalent carboxylic acids to a polycondensation reaction through an esterification reaction or a transesterification reaction by a known method.

The conditions in the condensation polymerization reaction are to be appropriately set according to the reactivity of the monomer components, and the reaction is to be terminated when the polymer has suitable physical properties. For example, the reaction temperature is approximately from 170° C. to 250° C., and the reaction pressure is approximately from 5 mm Hg to normal pressure.

Examples of the dihydric alcohol component include alkylene oxide adducts of bisphenol A, such as poly(oxypropylene)(2.2)-2,2-bis(4-hydroxyphenyl)propane, poly(oxypropylene)(3.3)-2,2-bis(4-hydroxyphenyl)propane, poly(oxypropylene)(2.0)-2,2-bis(4-hydroxyphenyl)propane, poly(oxypropylene)(2.0)-poly(oxyethylene)(2.0)-2,2-bis(4-hydroxyphenyl)propane, and poly(oxypropylene)(6)-2,2-bis(4-hydroxyphenyl)propane; diols, such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol; bisphenol A; propylene adducts of bisphenol A; ethylene adducts of bisphenol A; and hydrogenated bisphenol A.

Examples of the trihydric or higher polyhydric alcohol component include sorbitol, 1,2,3,6-hexanetetrol, 1,4-sorbitan, pentaerythritol, dipentaerythritol, tripentaerythritol, sucrose (cane sugar), 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

In the toner particles according to the present embodiment, one of the dihydric alcohol component and the polyhydric alcohol component having three or more hydroxyl groups may be used alone, or two or more thereof may be used in combination.

Examples of the divalent carboxylic acid include maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, n-dodecenylsuccinic acid, n-dodecylsuccinic acid, n-octylsuccinic acid, isooctenylsuccinic acid, isooctylsuccinic acid, and acid anhydrides and lower alkyl esters of these.

Examples of the trivalent or higher polycarboxylic acid include 1,2,4-benzenetricarboxylic acid, 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, Empol trimer acid, and acid anhydrides and lower alkyl esters of these.

In the toner particles according to the present embodiment, one of the divalent carboxylic acid and the polyvalent carboxylic acid having a valency of 3 or more may be used alone, or two or more thereof may be used in combination.

The weight average molecular weight of the polyester-based resin is preferably in a range from 3000 to 50000. When the weight average molecular weight is less than the lower limit, the releasability at the high temperature side of the fixable region (non-offset region) may be deteriorated. On the other hand, when the weight average molecular weight exceeds the upper limit, low-temperature fixability may be deteriorated.

The polyester-based resin preferably has an acid value in a range from 5 mgKOH/g to 30 mgKOH/g. When the acid value is less than the lower limit, the charging property of the polyester-based resin decreases and the charge control agent becomes difficult to disperse in the polyester-based resin, which may adversely affect the charge rising property and the charge stability during continuous printing. On the other hand, when the acid value exceeds the upper limit, the hygroscopicity may increase and the charging property may become unstable.

### Colorant

The toner particles according to the present embodiment contain a colorant. As the colorant, organic pigments, organic dyes, inorganic pigments, inorganic dyes, and the like used in the field of electrophotography can be used.

Examples of a black colorant include carbon black, copper oxide, manganese dioxide, aniline black, activated carbon, nonmagnetic ferrite, magnetic ferrite, and magnetite.

Examples of a yellow colorant include C.I. Pigment Yellow 12, C.I. Pigment Yellow 13, C.I. Pigment Yellow 14, C.I. Pigment Yellow 15, C.I. Pigment Yellow 17, C.I. Pigment Yellow 74, C.I. Pigment Yellow 93, C.I. Pigment Yellow 94, C.I. Pigment Yellow 138, C.I. Pigment Yellow 180, and C.I. Pigment Yellow 185.

Examples of a magenta colorant include C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, and C.I. Pigment Red 222.

Examples of a cyan colorant include C.I. Pigment Blue 15, C.I. Pigment Blue 15:2, C.I. Pigment Blue 15:3, C.I. Pigment Blue 16, and C.I. Pigment Blue 60.

The content of the colorant in the toner particles is preferably in a range from 3 parts by mass to 10 parts by mass. Note that to uniformly disperse the colorant in the binder resin, the colorant may be used in the form of masterbatch.

### Release Agent

The toner particles according to the present embodiment contain a wax as a release agent. As the wax, waxes used in the field of electrophotography can be used, and examples thereof include paraffin wax, microcrystalline wax, Fischer-Tropsch wax, polyethylene wax, polypropylene wax, carnauba wax, and synthetic ester wax. These waxes may be used alone or in combination of two or more kinds thereof.

The content of the release agent in the toner particle is preferably in a range from 0.5 mass % to 10 mass %.

### Charge Control Agent

The toner particles according to the present embodiment may contain a charge control agent. The charge control agent is added to impart a preferable charging property to the toner. The charge control agent is not particularly limited, and charge control agents for positive charge control and negative charge control used in the field of electrophotography can be used.

Examples of a charge control agent for positive charge control include quaternary ammonium salts, pyrimidine compounds, triphenylmethane derivatives, guanidine salts, and amidine salts.

Examples of a charge control agent for negative charge control include metal-containing azo compounds, azo complex dyes, metal complexes and metal salts of salicylic acid and derivatives thereof (the metal is chromium, zinc, zirconium, or the like), organic bentonite compounds, and boron compounds.

These charge control agents may be used individually, or two or more may be used in combination. The content of the charge control agent in the toner particle is preferably in a range from 0.5 mass % to 5 mass %.

### 2. External Additive

In the toner according to the present embodiment, an external additive may be attached to the surface of the toner particles, and silica fine particles are suitable as the external additive. By using the silica fine particles as the external additive, appropriate fluidity can be imparted to the toner. As a result, the stirring performance in the developer can be enhanced, so that the formation of the electroconductive path can be promoted.

Examples of the silica fine particles as the external additive include silica fine particles commonly used in the art, for example, fumed silica obtained by burning silicon tetrachloride, dry-process silica such as arc process silica obtained by atomizing silica in a gas phase by high energy such as plasma, precipitated silica synthesized under an alkaline condition using a sodium silicate aqueous solution as a raw material, wet-process silica such as gel process silica synthesized under an acidic condition, colloidal silica obtained by making acidic silicic acid alkaline and polymerizing the acidic silicic acid, sol-gel process silica obtained by hydrolyzing an organosilane compound, and the like. The surface of the silica fine particles may be hydrophobized with a silane compound in order to improve the electrical characteristics of the photoreceptor. Examples of the hydrophobic treatment include surface coating with a silane coupling agent.

As the silica particles serving as the external additive, commercially available hydrophobized silica particles may be used, or non-hydrophobized silica particles may be subjected to a treatment before use.

In the toner according to the present embodiment, the coverage ratio of the surface of the toner particle with the silica fine particles as the external additive is preferably in a range from 70% to 110%, and more preferably in a range from 90% to 100%. When the coverage ratio by the silica fine particles is within the above range, the heat resistance can be enhanced without deteriorating the fixability of the toner.

The adhesion strength of the silica fine particles as an external additive to the toner particles according to the present embodiment is preferably in a range from 50% to 80%, and more preferably in a range from 50% to 70%. When the adhesion strength of the silica fine particles exceeds the upper limit, the silica fine particles are in a state of being embedded in the surface of the toner particle, and desired fluidity cannot be imparted. When the adhesion strength of the silica fine particles is less than the lower limit, the silica fine particles are easily detached from the surface of the toner particle, and external additive contamination is likely to occur.

### 3. Method of Producing Toner

The method of producing a toner according to the present embodiment includes a melt-kneading step S1 in which a mixture of toner raw materials is melt-kneaded, a coarse pulverization step S2 in which the melt-kneaded product obtained in the melt-kneading step S1 is coarsely pulverized, an inorganic fine particle mixing step S3 in which the coarsely pulverized product obtained in the pulverization step S2 is mixed with inorganic fine particles, a fine pulverization step S4 in which the coarsely pulverized product containing the inorganic fine particles obtained in the inorganic fine particle mixing step S3 is finely pulverized, and a classification step S5 in which the finely pulverized product obtained in the fine pulverization step S4 is classified.

In the melt-kneading step S1, toner raw materials such as binder resins, colorants, and release agents are mixed with a mixer such as a Henschel mixer, and then kneaded with a kneader to obtain a melt-kneaded product.

The mixing is preferably performed by a dry method, and a known apparatus commonly used in the art can be used as a mixer. Examples thereof include Henschel type mixing devices such as a Henschel mixer (product name, manufactured by Nippon Coke & Engineering Co., Ltd.), a super mixer (product name, manufactured by Kawata Seiko Co., Ltd.), and a Mechano mill (product name, manufactured by Okada Seiko Co., Ltd.), and mixers such as an Ong mill (product name, manufactured by Hosokawa Micron Corporation), a hybridization system (product name, manufactured by Nara Machinery Co., Ltd.), and a Cosmo system (product name, manufactured by Kawasaki Heavy Industries, Ltd.).

As the kneading machine, a known apparatus commonly used in the art can be used, and examples thereof include general kneading machines such as a twin-screw extruder, a three roll mill, and a laboplast mill. Specific examples thereof include single-screw or twin-screw extruders such as TEM 100B (product name, manufactured by Toshiba Machine Co., Ltd.), PCM-65/87, and PCM-30 (all product names, manufactured by Ikegai Corp.), and open roll type kneaders such as Kneadex (product name, manufactured by Nippon Coke & Engineering Co., Ltd.). Among these, the open roll type kneader is preferable in that the shear at the time of kneading is strong and the toner material can be highly dispersed.

In the coarse pulverization step S2, the melt-kneaded product obtained in the melt-kneading step S1 is cooled and solidified, and coarsely pulverized using a pulverizer to obtain a coarsely pulverized product (toner flakes) having a mean particle size in a range from 1 mm to 10 mm. As the pulverizer, a known apparatus commonly used in the art can be used, and examples thereof include a speed mill, a hammer mill, and a cutting mill.

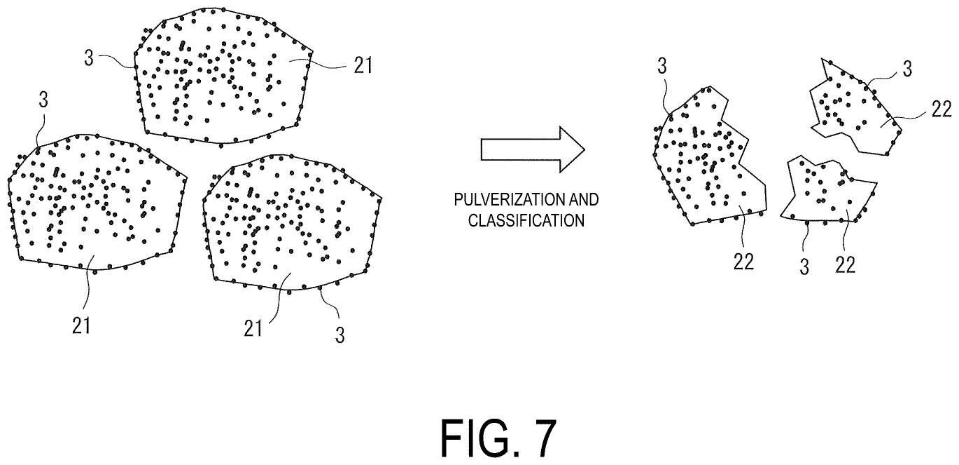

As illustrated in FIG. 7, in the method of producing a toner according to the present embodiment, a coarsely pulverized product 21 and the inorganic fine particles 3 are mixed in the inorganic fine particle mixing step S3, and then the fine pulverization step S4 and the classifying step S5 are performed. Since the inorganic fine particles 3 are hardly present on the surface (pulverized surface) formed by pulverizing the coarsely pulverized product 21 in the fine pulverization step S4, an interface α having a small abundance ratio of the inorganic fine particles 3 and an interface β having a large abundance ratio of the inorganic fine particles 3 are formed in a finely pulverized product 22. In addition, a toner particle in which the inorganic fine particles 3 are embedded is obtained by adopting such a step order.

In the inorganic fine particle mixing step S3, the coarsely pulverized product obtained in the coarse pulverization step S2 and the inorganic fine particles are mixed. The amount of the inorganic fine particles added relative to 100 parts by mass of the coarsely pulverized product (toner raw material) is preferably in a range from 2 parts by mass to 10 parts by mass, and more preferably in a range from 4 parts by mass to 8 parts by mass. As a mixer used for this mixing, a known apparatus commonly used in the art can be used.

In the fine pulverization step S4, the coarsely pulverized product (coarsely pulverized product containing inorganic fine particles) obtained in the inorganic fine particle mixing step S3 is finely pulverized. As the pulverizer, a known apparatus commonly used in the art can be used, and examples thereof include a jet-type pulverizer that performs pulverization using a supersonic jet stream, and an impact-type pulverizer that performs pulverization by introducing a solidified product into a space formed between a rotor rotating at a high speed and a stator (liner).

In the classification step S5, the finely pulverized product obtained in the fine pulverization step S4 is classified using a classifier. For the classification, a known apparatus commonly used in the art can be used. A classifier capable of removing excessively pulverized toner particles by centrifugal force and wind force, such as a swing type wind classifier (rotary type wind classifier), is suitable.

In the external addition step S6, the external additive is adhered to the toner particles by mixing the toner particles obtained in the classification step S5 and the external additive using a mixer. As the mixer, a known apparatus commonly used in the art can be used. Examples thereof include Henschel type mixing devices such as a Henschel mixer (product name, manufactured by Nippon Coke & Engineering Co., Ltd.), a super mixer (product name, manufactured by Kawata Seiko Co., Ltd.), and a Mechano mill (product name, manufactured by Okada Seiko Co., Ltd.), and mixers such as an Ong mill (product name, manufactured by Hosokawa Micron Corporation), a hybridization system (product name, manufactured by Nara Machinery Co., Ltd.), and a Cosmo system (product name, manufactured by Kawasaki Heavy Industries, Ltd.).

### EXAMPLES

Hereinafter, the toner of the present disclosure and the method of producing the same will be specifically described based on Examples and Comparative Examples.

### 1. Measurement Method

### Measurement Method of Adhesion Strength

A toner sample obtained by performing the adhesion removal process illustrated in the following (1) to (6) is referred to as “Sample 1”, and a toner sample before performing the adhesion removal process is referred to as “Sample 2”.

### Adhesion Removal Process

(1) 40 ml of a 0.2 mass % aqueous polyoxyethylene octylphenyl ether (manufactured by The Dow Chemical Company, product name: TRITON), 2.0 g of the toner is added and stirred for 1 minute.
(2) The aqueous solution obtained in (1) is irradiated with ultrasonic waves having an output of 40 μA for 4 minutes using an ultrasonic homogenizer (manufactured by Nissei Co., Ltd., model: US-300T).
(3) The aqueous solution after the ultrasonic irradiation is allowed to stand for 3 hours to separate the toner and the adhesion.
(4) After removing the supernatant, about 50 mL of pure water is added to the precipitate, and the mixture is stirred for 5 minutes.
(5) The mixture is suction-filtered using a membrane filter with a pore size of 1 μm (available from Advantec Co., Ltd.).
(6) The toner remaining on the membrane filter is vacuum-dried overnight.

Next, the X-ray intensity of a specific element in the adhesion at the 1 g of each of “Sample 1” and “Sample 2” is analyzed with an X-ray fluorescence analyzer (manufactured by Rigaku Corporation, model: ZSX Primus II). Based on the analysis results, the adhesion strength of the adhesion (the inorganic fine particles or the external additive present at the interface) to the toner particle is calculated by the following formula. The specific element is “Si” in the silica fine particles, “Sr” in the strontium titanate fine particles, “Al” in the alumina fine particles, and “Ti” in the titania fine particles.

Adhesion strength=(X-ray intensity in Sample 2)/(X-ray intensity in Sample 1)×100

### Measurement Method of Abundance Ratio of Inorganic Fine Particles

The toner is mixed with an epoxy-based resin (manufactured by DEVCON, product name: DEV-TUBE 5-31), and the mixture is poured into a mold and allowed to stand for 24 hours or more to cure the resin, thereby obtaining a cured sample. Subsequently, an ultrathin section (thickness UC7) of the cured sample is cut out using a microtome (manufactured by Leica Camera AG, model: Ultramicrotome EM 60 nm). The cut ultrathin section is sampled on a grid (manufactured by Nisshin EM Co., Ltd., product name: EM Fine Grid F-200). The sample on the grid is subjected to vapor phase staining for about 1 minute using a 0.5% aqueous solution of ruthenium (VIII) tetroxide. The dyed sample is photographed using a scanning electron microscope (SEM, manufactured by Hitachi High-Technologies Corporation, model: S-4800). The cross-section of the toner particle is photographed by the above procedure.

Next, an image of a target region (a region corresponding to the toner layers A to C or a region corresponding to the interface α or the interface j) for measuring the abundance ratio of the inorganic fine particles is cut out from the photographed cross-sectional image of the toner particle, and the “abundance ratio of the inorganic fine particles” is calculated by the following formula based on the occupancy ratio of the inorganic fine particles in the range of the cut-out image. The cutting of the image is performed so that the number n of the inorganic fine particles in the range of the cut image is 50<n. In the following formula, d is the mean particle size of the inorganic fine particles, n is the number of the inorganic fine particles within the range of the cut image, and A is the area of the entire range of the cut image.

$$ABUNDANCE RATIO [ \% ] = \frac{{π ( \frac{d}{2} )}^{2} \times n \times 100}{A} \qquad [ Equation 1 ]$$

### Measurement Method of Average Particle Size of External Additive

The toner is photographed with a scanning electron microscope (SEM, manufactured by Hitachi High-Technologies Corporation, model: S-4800), the particle sizes (long diameters) of 100 arbitrary external additives on the toner particle surface are measured from the obtained image, and the average value thereof is taken as the mean particle size of the external additive.

### Measurement Method of Average Particle Size of Inorganic Fine Particles

The particle sizes (major axes) of 100 arbitrary inorganic fine particles present in the toner layer B are measured from the image photographed in the above “Measurement Method of Abundance Ratio of Inorganic Fine Particles”, and the average value thereof is defined as the mean particle size of the inorganic fine particles.

### Measurement Method of Coverage Ratio of Toner Particle Surface by External Additive

The toner is photographed with a scanning electron microscope (SEM, manufactured by Hitachi High-Technologies Corporation, model: S-4800). The coverage ratio F by the external additive is calculated using the following formula derived from the model calculation with the projected area. In the following formula, D is the mean particle size of the toner particles, ρₜ is the specific gravity of the toner particles, d is the mean particle size of the external additive, ρ_{I} is the specific gravity of the external additive, and C is the number of parts by mass of the external additive added.

$$F = \frac{\sqrt{3}}{2 π} * \frac{{ρ}_{t} D}{{ρ}_{t} d} * C \qquad [ Equation 2 ]$$

### 2. Production of Toner and Two-Component Developer

### Example 1

### Melt-Kneading Step

The toner raw materials used in the melt-kneading step are as follows.
Binder resin: 83 mass % of amorphous polyester-based resin
Colorant: 6 mass % of C. I. Pigment Red 269
Release agent: 4 mass % of WE-22 (product name, manufactured by NOF Corporation)
Charge control agent: 1 mass % of salicylic acid-based compound
6 mass % of crystalline polyester-based resin

The above-mentioned toner raw materials were premixed for 5 minutes using a Henschel mixer (manufactured by Nippon Coke & Engineering Co., Ltd., model: FM20C) and then melt-kneaded using an open roll type continuous kneader (manufactured by Nippon Coke & Engineering Co., Ltd., model: MOS320-1800), to obtain a melt-kneaded product. As the setting conditions of the open roll, the supply-side temperature of the heating roll was 150° C., the discharge-side temperature was 125° C., the supply-side temperature of the cooling roll was 20° C., and the discharge-side temperature was 20° C. As the heat roll and the chill roll, rolls having diameters of 320 mm and effective lengths of 1550 mm were used, and the gaps between the rolls on the feed side and the discharge side were both set to 0.3 mm. The rotation speed of the heat roll was set to 75 rpm, the rotation speed of the chill roll was set to 65 rpm, and the supply amount of the toner raw materials was set to 6.5 kg/h.

### Coarse Pulverization Step

The obtained melt-kneaded product was cooled with a cooling belt, and then coarsely pulverized using a speed mill having a φ 2 mm screen to obtain a coarsely pulverized product.

### Inorganic Fine Particle Mixing Step

To 100 parts by mass of the obtained coarsely pulverized product, 6.0 parts by mass of strontium titanate fine particles (manufactured by Titan Kogyo, Ltd., product name: SWS-450CF, mean particle size: 34 nm) as inorganic fine particles was added, and the mixture was stirred for 1 minute with a Henschel mixer (manufactured by Nippon Coke & Engineering Co., Ltd., model: FM20C) in which the tip speed of a stirring blade was set to 20 m/sec, thereby obtaining an inorganic fine particle-added coarsely pulverized product.

### Fine Pulverization Step

The obtained inorganic fine particle-added coarsely pulverized product was finely pulverized using a jet type pulverizer (manufactured by Nippon Pneumatic Mfg. Co., Ltd., model: IDS-2) to obtain a finely pulverized product.

### Classification Step

The obtained finely pulverized product was classified using an elbow jet classifier (manufactured by Nittetsu Mining Co., Ltd., model: EJ-LABO) to obtain toner particles. The obtained toner particles had a mean particle size of 6.2 μm.

### External Addition Step

A toner was obtained by stirring 100 parts by mass of the obtained toner particles and 1.2 parts by mass of silica fine particles (manufactured by Nippon Aerosil Co., Ltd., product name: RX200, mean particle size: 7 nm) for 2 minutes with a Henschel mixer (manufactured by Nippon Coke & Engineering Co., Ltd., model: FM20C) in which the tip speed of a stirring blade was set to 40 m/sec.

### Production Step of Two-Component Developer

The obtained toner and a resin-coated carrier are mixed so that the concentration of the toner with respect to the total amount of the two-component developer is adjusted to 7%, thereby obtaining a two-component developer having a toner concentration of 7%.

Examples 2 to 6 and 9 to 12, 17, 18, Comparative Examples 1 to 3 Toner particles, a toner, and a two-component developer are obtained in the same manner as in Example 1 except that the type and the number of parts of the inorganic fine particles added, and the coverage ratio with the external additive are changed as illustrated in Table 1 below. The inorganic fine particles used in Example 17 were alumina-coated silica fine particles (manufactured by Tayca Corporation, product name: MSW-02, mean particle size 15 nm), and the inorganic fine particles used in Example 18 were titania fine particles (manufactured by Titan Kogyo, Ltd., product name: ST-550R, mean particle size 40 nm). In addition, the inorganic fine particles used in Comparative Example 1 were silica fine particles (manufactured by Nippon Aerosil Co., Ltd., product name: RX200, mean particle size 12 nm), the inorganic fine particles used in Comparative Example 2 were silica fine particles (manufactured by Nippon Aerosil Co., Ltd., product name: R976S, mean particle size 7 nm), and the inorganic fine particles used in Comparative Example 3 were strontium titanate fine particles (manufactured by Titan Kogyo, Ltd., product name: SW-100, mean particle size 390 nm).

### Examples 7 and 8

Toner particles, a toner, and a two-component developer were obtained in the same manner as in Example 1, except that in the fine pulverization step and the classification step, the adhesion strength of the inorganic fine particles illustrated in Table 1 below was adjusted by adjusting the air flow rate and the number of revolutions while keeping the mean particle size of the obtained toner particles at 6.2 μm.

### Example 13

Toner particles, a toner, and a two-component developer are obtained in the same manner as in Example 1 except that the stirring time in the external addition step is changed to 3 minutes.

### Example 14

Toner particles, a toner, and a two-component developer are obtained in the same manner as in Example 1 except that the stirring time in the external addition step is changed to 1 minute and 30 seconds.

### Example 15

In the external addition step, first, 100 parts by mass of the obtained toner particles and 1.2 parts by mass of silica fine particles (manufactured by Nippon Aerosil Co., Ltd., product name: RX200, mean particle size 7 nm) were stirred for 2 minutes with a Henschel mixer (manufactured by Nippon Coke & Engineering Co., Ltd., model: FM20C) in which the tip speed of a stirring blade was set to 40 m/sec (first stirring). Next, the stirred product obtained by the first stirring was further stirred for 2 minutes under the same conditions as in the first stirring (second stirring) to obtain a toner. Toner particles, a toner, and a two-component developer are obtained in the same manner as in Example 1 except that the external addition step is changed as described above.

### Example 16

Toner particles, a toner, and a two-component developer are obtained in the same manner as in Example 1 except that the stirring time in the external addition step is changed to 1 minute.

### Comparative Example 4

Toner particles having a mean particle size of 6.2 μm were obtained in the same manner as in Example 1 by performing the steps up to the coarse pulverization step in the same manner as in Example 1 and finely pulverizing and classifying the coarsely pulverized product without performing the inorganic fine particle mixing step (finely pulverizing and classifying a coarsely pulverized product to which inorganic fine particles were not added). A toner was obtained in the same manner as in Example 1 except that strontium titanate fine particles were added in addition to the silica fine particles in the external addition step. A two-component developer was prepared in the same manner as in Example 1.

TABLE 1

| | Inorganic Fine Particles Contained Inside Toner Particles | | | | | | | | | | |
|---|---|---|---|---|---|---|---|---|---|---|---|
| | | | | | | | | Number | | | |
| | | | | | | | | of parts | | | |
| | | | | | | | | [parts] | | | |
| | | | | | | | | added | | | |
| | | | | | | | | with | | | |
| | | | | | | | | respect | | | |
| | | | Layer | | | | | to 100 | Mass | External Additive | |
| | | | having the | | Abundance | Abundance | | parts of | Ratio in | (Silica) | |
| | Type of | Particle | maximum | Abundance | ratio at | ratio at | Adhesion | toner | Toner | | Adhesion |
| | fine | size | abundance | Ratio | interface α | interface β | Strength | raw | Particle | Coverage | Strength |
| | particles | (nm) | ratio | R_{α}/R_{β} [%] | R_{α} [%] | R_{β} [%] | [%] | material | [mass %] | Ratio [%] | [%] |
| Example 1 | Strontium | 34 | Toner | 4.1 | 4 | 98 | 96 | 6 | 5.7 | 94 | 58 |
| | titanate | | layer B | | | | | | | | |
| Example 2 | Strontium | 34 | Toner | 3.3 | 3 | 92 | 96 | 3 | 2.9 | 94 | 58 |
| | titanate | | layer B | | | | | | | | |
| Example 3 | Strontium | 34 | Toner | 10.1 | 10 | 99 | 97 | 10 | 9.1 | 94 | 38 |
| | titanate | | layer B | | | | | | | | |
| Example 4 | Strontium | 34 | Toner | 2.2 | 2 | 90 | 98 | 2 | 2.0 | 94 | 58 |
| | titanate | | layer B | | | | | | | | |
| Example 5 | Strontium | 34 | Toner | 14.1 | 14 | 99 | 98 | 12 | 10.7 | 94 | 58 |
| | titanate | | layer B | | | | | | | | |
| Example 6 | Strontium | 34 | Toner | 1.7 | 1 | 60 | 98 | 1 | 1.0 | 94 | 58 |
| | titanate | | layer B | | | | | | | | |
| Example 7 | Strontium | 34 | Toner | 5.2 | 5 | 97 | 90 | 6 | 5.7 | 94 | 58 |
| | titanate | | layer B | | | | | | | | |
| Example 8 | Strontium | 34 | Toner | 7.2 | 7 | 97 | 80 | 6 | 5.7 | 94 | 58 |
| | titanate | | layer B | | | | | | | | |
| Example 9 | Strontium | 34 | Toner | 4.1 | 4 | 98 | 96 | 6 | 5.7 | 110 | 58 |
| | titanate | | layer B | | | | | | | | |
| Example 10 | Strontium | 34 | Toner | 4.1 | 4 | 98 | 96 | 6 | 5.7 | 70 | 58 |
| | titanate | | layer B | | | | | | | | |
| Example 11 | Strontium | 34 | Toner | 4.1 | 4 | 98 | 96 | 6 | 5.7 | 130 | 58 |
| | titanate | | layer B | | | | | | | | |
| Example 12 | Strontium | 34 | Toner | 4.1 | 4 | 98 | 96 | 6 | 5.7 | 50 | 52 |
| | titanate | | layer B | | | | | | | | |
| Example 13 | Strontium | 34 | Toner | 4.1 | 4 | 98 | 96 | 6 | 5.7 | 94 | 80 |
| | titanate | | layer B | | | | | | | | |
| Example 14 | Strontium | 34 | Toner | 4.1 | 4 | 98 | 96 | 6 | 5.7 | 94 | 50 |
| | titanate | | layer B | | | | | | | | |
| Example 15 | Strontium | 34 | Toner | 4.1 | 4 | 98 | 96 | 6 | 5.7 | 94 | 95 |
| | titanate | | layer B | | | | | | | | |
| Example 16 | Strontium | 34 | Toner | 4.1 | 4 | 98 | 96 | 6 | 5.7 | 94 | 30 |
| | titanate | | layer B | | | | | | | | |
| Example 17 | Alumina- | 15 | Toner | 4.1 | 4 | 98 | 96 | 6 | 5.7 | 94 | 58 |
| | coated | | layer B | | | | | | | | |
| | silica | | | | | | | | | | |
| Example 18 | Titania | 40 | Toner | 4.1 | 4 | 98 | 95 | 7 | 6.5 | 94 | 58 |
| | | | layer B | | | | | | | | |
| Comparative | Silica | 12 | Toner | 4.1 | 4 | 98 | 96 | 2 | 2.0 | 94 | 58 |
| Example 1 | | | layer B | | | | | | | | |
| Comparative | Silica | 7 | Toner | 3.3 | 3 | 92 | 96 | 2 | 2.0 | 94 | 58 |
| Example 2 | | | layer B | | | | | | | | |
| Comparative | Strontium | 390 | Toner | 6.7 | 6 | 90 | 70 | 4 | 3.8 | 94 | 58 |
| Example 3 | titanate | | layer B | | | | | | | | |
| Comparative | Strontium | 34 | Toner | 100.0 | 90 | 90 | 90 | 6 | 5.7 | 94 | 58 |
| Example 4 | titanate | | layer A | | | | | | | | |

Table 1 summarizes the type, mean particle size, and number of parts added of the inorganic fine particles used in the inorganic fine particle mixing step, the coverage ratio by the external additive, and the various measurement results.

### 4. Evaluation

### Evaluation Item 1: Evaluation of Charging Characteristics (Environmental Charging Characteristics)

0.3 g of the toner and 3.7 g of the carriers were weighed in a screw tube, and the screw tube was allowed to stand for 24 hours in each environmental chamber (NL environmental chamber at 25° C. and 5% RH, NN environmental chamber at 25° C. and 50% RH, and HH environmental chamber at 35° C. and 80% RH) with the lid of the screw tube removed. Next, the lid of the screw tube was closed in the environmental chamber, and the screw tube was shaken for 1 minute at 25.3 Hz using a mixer mill (manufactured by Verder Scientific Co., Ltd., model: MM200), and the charge amount (C/g) of the two-component developer in each of the environments was measured using a suction-type charge amount measuring apparatus (manufactured by Trek, Inc., model: Model210HS). From the difference in the charge amount in each environment, the environmental charging characteristics were evaluated according to the following criteria.
⊚ (Excellent): The difference in the charge amount in each environment is 5 μC/g or less.
◯ (Good): The difference in the charge amount in each environment is more than 5 μC/g and 10 μC/g or less.
Δ (Fair): The difference in the charge amount in each environment is more than 10 μC/g and 15 μC/g or less.
X (Poor): The difference in charge amount in each environment is more than 15 μC/g.

### Evaluation Item 2: Evaluation Based on Fogging Value

An image in which a region of 10% with respect to a printable area of a recording sheet (PPC paper manufactured by Sharp Corporation, model: SF-5100FN) was filled with a toner was printed using a modified commercially available copier (manufactured by Sharp Corporation, model: MX-4AM3) as an evaluation machine, and the lightness of a specific place which was not filled was measured using a colorimetric color difference meter (manufactured by Nippon Denshoku Industries Co., Ltd., model: ZE6000). The difference between this lightness and the lightness measured in advance before printing was taken as the fogging value. Based on the measured fogging value, evaluation was made according to the following criteria. The specified value of the fogging value refers to a specified value determined by the evaluation machine and the evaluation content.
⊚ (Excellent): The measured value is 80% or less of the specified value of the fogging value.
◯ (Good): The measured value is more than 80% and 90% or less with respect to the specified value of the fogging value.
Δ (Fair): The measured value is more than 90% and 100% or less with respect to the specified value of the fogging value.
X (Poor): The measured value is more than 100% with respect to the specified value of the fogging value.

### Evaluation Item 3: Evaluation of Fixability (Low-Temperature Fixability)

A fixed image was formed with a two-component developer using a modified commercially available copier (manufactured by Sharp Corporation, model: MX-5100FN) as an evaluation machine. First, a sample image including a solid image (a rectangle 20 mm long and 50 mm wide) was formed as an unfixed image on a recording sheet (PPC sheet available from Sharp Corporation, model: SF-4AM3). At this time, the adhesion amount of the toner to the recording sheet in the solid image was adjusted to 0.5 mg/cm².

Next, a fixed image was formed using a hard roller fixing apparatus. The fixing process speed was set to 283 mm/sec, and the temperature of the fixing roller was raised from 110° C. in increments of 5° C. to determine the lowest temperature at which cold offset did not occur. Here, the “low-temperature offset” means that the toner is not fixed to the recording paper at the time of fixing, and is attached to the recording paper after the fixing belt makes one revolution while the toner is attached to the fixing belt. From the obtained results, the “low-temperature fixability” was evaluated according to the following criteria.
⊚ (Excellent): The lowest temperature is less than 110° C.
◯ (Good): The lowest temperature is in a range from 110° C. or higher and lower than 120° C.
Δ (Fair): The lowest temperature is 120° C. or higher and lower than 130° C.
X (Poor): The lowest temperature is 130° C. or higher.

### Comprehensive Assessment

Based on the results of the above evaluation items 1 to 3, comprehensive assessment was made according to the following criteria.
⊚ (Excellent): All evaluation items are ⊚. Available.
◯ (Good): The lowest evaluation among all the evaluation items is ◯. Available.
Δ (Fair): The lowest evaluation among all the evaluation items is Δ: Available.
X (Poor): The lowest evaluation among all the evaluation items is X. Unusable.

TABLE 2

| | Evaluation | | | |
|---|---|---|---|---|
| | Charging | Fogging | | Comprehensive |
| | characteristics | value | Fixability | assessment |
| Example 1 | Excellent | Excellent | Excellent | Excellent |
| Example 2 | Excellent | Excellent | Excellent | Excellent |
| Example 3 | Excellent | Good | Good | Good |
| Example 4 | Good | Good | Good | Good |
| Example 5 | Good | Fair | Good | Fair |
| Example 6 | Fair | Good | Good | Fair |
| Example 7 | Good | Good | Excellent | Good |
| Example 8 | Good | Fair | Good | Fair |
| Example 9 | Excellent | Good | Good | Good |
| Example 10 | Good | Good | Good | Good |
| Example 11 | Good | Fair | Fair | Fair |
| Example 12 | Fair | Good | Good | Fair |
| Example 13 | Good | Good | Good | Good |
| Example 14 | Good | Good | Good | Good |
| Example 15 | Fair | Good | Good | Fair |
| Example 16 | Good | Fair | Good | Fair |
| Example 17 | Good | Good | Good | Good |
| Example 18 | Good | Fair | Good | Fair |
| Comparative | Poor | Poor | Good | Poor |
| Example 1 | | | | |
| Comparative | Poor | Poor | Good | Poor |
| Example 2 | | | | |
| Comparative | Fair | Poor | Fair | Poor |
| Example 3 | | | | |
| Comparative | Good | Poor | Poor | Poor |
| Example 4 | | | | |

Table 2 illustrates the evaluation results of Examples and Comparative Examples. In the toner of Comparative Example 4, since the inorganic fine particles (strontium titanate fine particles) are added in the external addition step, the inorganic fine particles are evenly distributed on the surface of the toner particle, and there is no concept of the interfaces α and β having different abundance ratios of the inorganic fine particles, but in Table 2, the abundance ratio on the surface of the toner particle (toner layer A) is described in the columns of R_{α} and R_{β} of Comparative Example 4 for convenience.

As is clear from Tables 1 and 2, the toners of Examples 1 to 18, which had toner particles containing a binder resin, a colorant, and a release agent and satisfied the following requirements (A) to (E), had excellent charging characteristics and fixability and were capable of suppressing the occurrence of fogging.
(A) The toner particles contain inorganic fine particles having a mean particle size in a range from 10 nm to 60 nm.
(B) The inorganic fine particles are at least one selected from the group consisting of strontium titanate fine particles, alumina-coated silica fine particles, titania fine particles, alumina fine particles, zinc oxide fine particles, cerium oxide fine particles, and calcium carbonate fine particles.
(C) The toner layer B has a higher abundance ratio of the inorganic fine particles than the toner layer A and the toner layer C.
(D) In an electronic image of a cross section of the toner particle obtained by a scanning electron microscope, when a region corresponding to the toner layer B is defined as an interface, an interface α having a small abundance ratio of the inorganic fine particles and an interface β having a large abundance ratio of the inorganic fine particles are present, and an interface length of the interfaces α and β is 2 μm or more.
(E) The abundance ratio of the inorganic fine particles in the interface α is 15% or less of the abundance ratio of the inorganic fine particles in the interface β.

On the other hand, in Comparative Examples 1 to 4 in which these requirements were not satisfied, the evaluation results of at least one of the three evaluation items were inferior to those of Examples. Comparative Example 1 is an example that does not satisfy the requirement (B), Comparative Example 2 is an example that does not satisfy the requirements (A) and (B), and Comparative Example 3 is an example that does not satisfy the requirement (A). In addition, Comparative Example 4 is an example in which all of the above requirements are not satisfied since strontium titanate fine particles are added as an external additive.

In Comparative Examples 1 and 2 in which silica fine particles were used in the inorganic fine particle mixing step, it is considered that the silica fine particles have a high resistance value and do not exhibit a function as a charge adjustment agent, and the results of the evaluation of the charging characteristics in Table 2 were inferior to those of Examples. In addition, in the inorganic fine particle mixing step, when the inorganic fine particles were added in the same addition amount as in Example 1, 3, 4, the flowability imparting effect of the silica fine particles was high, so that the flowability was excessively increased to cause scattering of the toner, and the evaluation based on fogging was inferior to that of Examples.

In Comparative Example 3 in which the strontium titanate fine particles having a large mean particle size were used in the inorganic fine particle mixing step, although the fine particles were embedded in the toner particle surface, the embedding was shallow, and the exposure to the toner particle surface was increased as compared with the inorganic fine particles having a small particle size. Therefore, the adhesion strength of the fine particles to the toner particles is also reduced. In Comparative Example 3, since the exposure of the fine particles on the surface of the toner particle is large, the conductive path is easily formed, and the effect of improving the environmental charging characteristics can be expected, but it is considered that a decrease in the fogging suppression performance or fixing inhibition occurs due to the deterioration of the fluidity, the detachment of the external additive, or the like, and in Table 2, the evaluation based on the fogging value is inferior to Examples.

In Comparative Example 4, the evaluation based on the fogging value and the evaluation of the fixability were inferior to those of Examples. In Comparative Example 4, since the strontium titanate fine particles are externally added to the toner particles, the toner particles are evenly coated with the fine particles, and the concept of the interfaces α and β having different abundance ratios of the inorganic fine particles does not exist (in particular, the interface α having a small abundance ratio of the inorganic fine particles does not exist). The following two points are considered to be the reasons why such a toner is inferior in fixability.
(1) Since an excessive amount of inorganic fine particles is present, the fixing heat is taken away by the inorganic fine particles, the melting of the toner particles is inhibited, and fixing defects occur.
(2) Since the exposure of the toner particles is very small, the function of the release agent is inhibited at the time of fixing, the cohesive force between the toner particles is lowered, or the anchor effect between the toner and the paper is lowered, so that fixing failure occurs.

Next, when Examples are compared and examined, it is found that Example 3 in which the abundance ratio of the inorganic fine particles in the interface α is 10% or less is particularly excellent in the evaluation of the charging characteristics and the evaluation based on the fogging value as compared with Example 5 in which the abundance ratio exceeds the upper limit.

It can be seen that Example 4 in which the abundance ratio of the inorganic fine particles in the interface β is 90% or more is particularly excellent in the evaluation of the charging characteristics as compared with Example 6 in which the abundance ratio is less than the lower limit.

It can be seen that Example 7, in which the adhesion strength of the inorganic fine particles to the toner particles is 90% or more, is particularly superior to Example 8, in which the adhesion strength is less than the lower limit, in the evaluation based on the fogging value and the evaluation of the fixability.

It can be seen that Example 4 in which the content of the inorganic fine particles in the toner particles is 2 mass % or more is particularly excellent in the evaluation of the charging characteristics as compared with Example 6 in which the content is less than the lower limit. In addition, it can be seen that Example 3 in which the content of the inorganic fine particles in the toner particles is 10 mass % or less is particularly excellent in the evaluation based on the fogging value compared to Example 5 in which the content exceeds the upper limit.

It can be seen that Example 10, in which the coverage ratio of the toner particle surface by the silica fine particles as the external additive is 70% or more, is particularly superior in the evaluation of charging characteristics to Example 12, in which the coverage ratio is less than the lower limit set forth above. In addition, it can be seen that Example 9 in which the coverage ratio of the toner particle surface with the silica fine particles as the external additive is 110% or less is more excellent in the evaluation of all the evaluation items than Example 11 in which the coverage ratio exceeds the upper limit, and is particularly excellent in the evaluation of the charging characteristics.

It can be seen that Example 14 in which the adhesion strength of the silica fine particles to the toner particles is 50% or more is particularly excellent in the evaluation based on the fogging value as compared with Example 16 in which the adhesion strength is less than the lower limit. In addition, it is found that Example 13 in which the adhesion strength of the silica fine particles to the toner particles is 80% or less is particularly excellent in the evaluation of the charging characteristics as compared with Example 15 in which the adhesion strength exceeds the upper limit.

The embodiments disclosed herein are illustrative in all respects and are not the basis for a limited interpretation. Accordingly, the technical scope of the disclosure is not to be construed by the foregoing embodiments only, and is defined based on the description of the claims. In addition, meanings equivalent to the range of the claims and all changes made within the range are included.

### DESCRIPTION OF SYMBOLS

1 Toner
2 Toner particle
3 Inorganic fine particle
4 External additive
21 Coarsely pulverized product
22 Finely pulverized product
A Toner layer A
B Toner layer B
C Toner layer C

1. A toner comprising:
a toner particle containing a binder resin, a colorant and a release agent, wherein
the toner particle contains an inorganic fine particle having a mean particle size in a range from 10 nm to 60 nm,
the inorganic fine particle is at least one selected from the group consisting of a strontium titanate fine particle, an alumina-coated silica fine particle, a titania fine particle, an alumina fine particle, a zinc oxide fine particle, a cerium oxide fine particle, and a calcium carbonate fine particle,
when a layer having a depth from a surface of the toner particle in a range of 0 nm to 10 nm is defined as a toner layer A, a layer having a depth in a range from 10 nm to 100 nm is defined as a toner layer B, and a layer having a depth of 100 nm or more is defined as a toner layer C, the toner layer B has an abundance ratio of the inorganic fine particle higher than an abundance ratio of the toner layer A and the toner layer C,
in an electronic image of a cross-section of the toner particle obtained by a scanning electron microscope, when a region corresponding to the toner layer B is defined as an interface, an interface α having a small abundance ratio of the inorganic fine particle and an interface β having a large abundance ratio of the inorganic fine particle are present,
an interface length of the interface α and the interface β is 2 μm or more, and
an abundance ratio of the inorganic fine particle in the interface α is 15% or less of an abundance ratio of the inorganic fine particle in the interface β.

2. The toner according to claim 1 wherein
the inorganic fine particle is at least one selected from the group consisting of a strontium titanate fine particle, an alumina-coated silica fine particle, and a titania fine particle.

3. The toner according to claim 1, wherein
an abundance ratio of the inorganic fine particle in the interface α is 10% or less in an electronic image of a cross-section of the toner particle obtained by a scanning electron microscope.

4. The toner according to claim 1, wherein
an abundance ratio of the inorganic fine particle in the interface β is 90% or more in an electronic image of a cross-section of the toner particle obtained by a scanning electron microscope.

5. The toner according to claim 1, wherein
an adhesion strength of the inorganic fine particle to the toner particle is 90% or more.

6. The toner according to claim 1, wherein
a content of the inorganic fine particle in the toner particle is in a range from 2 mass % to 10 mass %.

7. The toner according to claim 1, wherein
a silica fine particle as an external additive is attached to a surface of the toner particle, and
a coverage ratio of the toner particle surface by the silica fine particle is in a range from 70% to 110%.

8. The toner according to claim 7, wherein
an adhesion strength of the silica fine particle to the toner particle is in a range from 50% to 80%.

9. A method of producing the toner according to claim 1, comprising:
a melt-kneading step of melt-kneading a mixture of raw materials containing a binder resin, a colorant, and a releasing agent;
a coarse pulverization step of coarsely pulverizing the melt-kneaded product obtained in the melt-kneading step;
an inorganic fine particle mixing step of mixing the coarsely pulverized product obtained in the coarse pulverization step with an inorganic fine particle;
a fine pulverization step of finely pulverizing a coarsely pulverized product containing the inorganic fine particle obtained in the inorganic fine particle mixing step; and
a classification step of classifying the finely pulverized product obtained in the fine pulverization step.
